(19) United States
(12) Patent Application Publication
(10) Pub. No.: US 2018/0198180 A1
(43) Pub. Date: Jul. 12, 2018

(54) ACCUMULATOR TEMPERATURE CONTROL ARRANGEMENT

(71) Applicant: Mahle International GmbH, Stuttgart (DE)

(72) Inventors: Sarah Gorzellik, Stuttgart (DE); Dieter Reisinger, Vaihingen/Enz (DE); Christoph Walter, Stuttgart (DE)

(73) Assignee: Mahle International GmbH, Stuttgart (DE)

(21) Appl. No.: 15/869,009

(22) Filed: Jan. 11, 2018

(30) Foreign Application Priority Data
Jan. 12, 2017 (DE) 102017200442.8

(51) Int. Cl. H01M 10/613; H01M 10/625; H01M 10/6554

(52) U.S. Cl. CPC H01M 10/613; H01M 10/4207; H01M 10/6554; H01M 10/625

(57) ABSTRACT

An accumulator temperature control arrangement for a motor vehicle may include an electrical accumulator and a temperature control device for controlling a temperature of the accumulator. The temperature control device may include at least one temperature control element in heat-exchanging contact with an underside of the accumulator. A pressing element may be arranged on a side of the at least one temperature control element facing away from the underside. The pressing element may pretension the at least one temperature control element in a direction of the underside. The arrangement may include at least one bracing element arranged on the underside and faces the pressing element. The pressing element may include a clamping component corresponding to the at least one bracing element and which, together with the at least one bracing element, provide a bracing device that may pretension the pressing element in the direction of the underside.

### CROSS-REFERENCE TO RELATED APPLICATIONS

This application claims priority to German Patent Application No. DE 10 2017 200 442.8, filed on Jan. 12, 2017, the contents of which are hereby incorporated by reference in its entirety.

### TECHNICAL FIELD

The invention at hand relates to an accumulator temperature control arrangement comprising an electrical accumulator and a temperature control device for controlling the temperature of the accumulator.

### BACKGROUND

Electrical accumulators serve to electrically supply a consumer. In a vehicle, such accumulators are used for example to drive the motor vehicle. In the case of a plurality of such consumers, in particular in a motor vehicle, the high demands on the accumulator require a temperature control, in particular a cooling, of the accumulator. Temperature control devices, which typically have a plurality of temperature control elements, which are in a heat-exchanging contact with one side of the accumulator, are used for this purpose. To increase the efficiency of the temperature control device and/or for a homogenous temperature control of the accumulator, it is known to pretension the temperature control elements against the corresponding side of the accumulator with the help of a pressing element.

To attain this pretensioning, it is conceivable on principle, to arrange the pressing element between the accumulator and the corresponding use, for example the motor vehicle, and to pretension it against both. It is a disadvantage hereby that the tolerances, which are to be compensated, in particular the tolerance chain, is increased hereby. In addition, mechanical stresses of the use, in particular vibrations of the use, are transferred to the pressing element and the accumulator, and lead for example to a reduced efficiency and/or to a reduced homogeneity of the temperature control of the accumulator.

It is known from DE 10 2013 225 628 A1 to arrange such a pressing element together with the accumulator inside a housing and to pretension it between the housing and such a temperature control element, which is also arranged in the housing, so as to thus pretension the temperature control element in the direction of the accumulator.

A battery comprising a plurality of battery cells, each of which have a cell housing, as well as a cooling plate for the cooling thereof, is known from DE 10 2008 034 854 A1. For a pretensioned fastening of the respective battery cell to the cooling plate, provision is made for a corresponding bracing device, which is embodied as elastic and power-transmitting device.

The disadvantage of the known solutions is a relatively large need for installation space. In addition, the common arrangement of the temperature control elements and of the accumulator in a housing can lead to damages to the accumulator, in particular when a temperature control medium, which flows through the temperature control elements, escapes from the temperature control elements.

### SUMMARY

The invention at hand thus deals with the object of specifying an improved or at least an alternative embodiment for an accumulator temperature control arrangement of the above-mentioned type, which is in particular characterized by a design, which saves installation space and/or by an increased operational safety and/or an improved homogeneity of the temperature control of the accumulator, and which can moreover be produced in a cost-efficient manner by means of a simplified production.

According to the invention, this object is solved by means of the subject matter of independent claim(s). Advantageous embodiments are the subject matter of the dependent claims.

The invention at hand is based on the general idea of fixing a pressing element in the direction of an underside of an accumulator with the help of a bracing device and to brace at least one temperature control element between the underside of the accumulator and the pressing element, in the case of an accumulator temperature control arrangement. For this purpose, a bracing element is arranged on the underside of the accumulator, which protrudes at least partially in the direction of the pressing element. The bracing element is thereby in an operative connection with a corresponding clamping means, which, together with the bracing element, forms the above-described bracing device and is embodied on the pressing element. The operative connection in the form of the pretensioning between the bracing element and the clamping means provides for the desired surface pressure between the at least one temperature control element and the underside of the accumulator. This results in a thermal contact, which is at least as optimal as possible, between the at least one temperature control element and the underside, whereby a homogenous cooling of accumulator cells, which abut directly or indirectly on the underside of an accumulator housing, is made possible. The pretensioning directly between the pressing element and the bracing element in the underside of the accumulator furthermore creates an accumulator temperature control arrangement, which is largely independent of external parts, which needs to compensate at least fewer tolerances and which is subjected to fewer mechanical stresses. The uncoupling from a motor vehicle bottom, for example, predominantly increases the operational safety of the accumulator temperature control arrangement. Due to the possible omission of further parts, which are arranged on the side of the pressing element, which faces away from the accumulator, the arrangement can moreover be embodied so as to save more installation space. It is further possible to arrange the temperature control elements as well as the pressing element outside of the housing of the accumulator, so that damages to the accumulator caused by the temperature control elements are prevented or at least reduced, and the operational safety is further improved. A facilitated assembly and disassembly is made possible by the embodiment with a releasable bracing device. Due to the provided bracing device, a production or an assembly, respectively, of the accumulator temperature control arrangement is further made possible without screws or the like, to fix the pressing element to the underside of the accumulator, whereby the level of complexity on the one hand and the production costs on the other hand can be reduced.

In accordance with the idea of the invention, the accumulator temperature control arrangement, in particular for the use in a motor vehicle, comprises such an electrical accumulator and a temperature control device for controlling the temperature of the accumulator, which has at least one such temperature control element, which is in heat-exchanging contact with the underside of the accumulator. The accumulator temperature control arrangement further comprises such a pressing element, which is arranged on the side of at least one such temperature control element, which faces away from the underside, and which pretensions at least one such temperature control element in the direction of the underside of the accumulator. To pretension the temperature control elements against the underside, the bracing device is provided, which is formed from the bracing element and the clamping means. The bracing element is arranged on the underside of the accumulator and can be clamped with the clamping means, which is embodied on the pressing element, at least in such a way that a pretensioning of the pressing element in the direction of the underside is made possible and that at least one such temperature control element can thus also be pretensioned in the direction of the underside. To that effect, a desired homogenous pressing between the at least one temperature control element and the underside of the accumulator can be attained with simple means.

In an advantageous further development of the idea according to the invention, the bracing element is embodied integrally on the underside of the accumulator. By means of the integral embodiment of the bracing element, an additional operating step for the subsequent attachment to the underside of the accumulator can be saved. The accumulator housing as well as the bracing element arranged thereon are preferably made as plastic injection molded parts, so that an injection molding tool for producing the accumulator housing is embodied in such a way that the bracing element can be molded uniformly as well.

In a further advantageous further development, provision is made for a plurality of bracing devices for bracing the pressing element, which are in particular embodied of bracing elements, which are embodied integrally or monolithically, respectively, and as clamping means, which are embodied integrally or monolithically, respectively. The integral or monolithic embodiment, respectively, of the bracing elements can be made as described above by means of an integral molding on the underside of the accumulator on the one hand and by means of an indirect or direct attaching to the underside of the accumulator on the other hand. For example, provision can be made for sheet metal strips, which are to be attached subsequently and on which at least one such bracing element and preferably a plurality of bracing elements are arranged.

An advantageous embodiment alternative provides for the bracing element to be embodied as a stepped shaft comprising a defined undercut and for the clamping means to be embodied as resilient clamping element, which is held on the stepped shaft in a non-positive and positive manner and which in particular locks in place with the stepped shaft. The resilient clamping element on the pressing element effects the pretensioning, by means of which the pressing element jams at least one such temperature control element to the underside of the accumulator.

In an advantageous embodiment alternative, the clamping element for holding the stepped shaft has two resilient semicircles, which are spaced apart from one another and which face one another. The semicircles preferably have a convex shape, whereby a locking in place between the clamping element and the bracing element is improved. At least one such clamping means is preferably made of a metallic material, in particular of a steel spring sheet.

In an advantageous further development of the described embodiment alternative, at least one such resilient semicircle has a tool accommodation, which is in particular embodied to release a locking connection. The tool accommodation serves for a simplified disassembly of the pressing element, in that the locking connections between the clamping means and the bracing elements can be released with the help of a tool.

A further advantageous embodiment alternative provides for the bracing element to be embodied as a first sheet metal strip, in particular comprising at least one latching bead, which protrudes therefrom in the direction of the clamping means, and for the clamping means to have a blanking, which corresponds to the first sheet metal strip or to such a latching bead, respectively, and for the first sheet metal strip or such a latching bead, respectively, to be in a non-positive and positive operative connection with the clamping means.

In an advantageous further development, the latching beads on the first sheet metal strip are embodied so as to alternate with the respective adjacent temperature control elements. This means that the latching beads are in each case arranged offset to one another, so that an unintentional release of the bracing device can be prevented.

In a further advantageous further development, the latching beads are moreover molded convexly to the respective adjacent temperature control elements, whereby the locking connection between the latching beads and the clamping means on the pressing element is improved.

In a further advantageous embodiment alternative of the idea according to the invention, the bracing element is embodied as a second sheet metal strip, in particular comprising locking elements, which protrude therefrom and which have an undercut. The clamping means hereby has a blanking, which corresponds to the locking elements and which provides for a non-positive and positive accommodation of the locking elements.

An advantageous further development of the embodiment alternative provides for the locking elements to be integrally molded on the second sheet metal strip. The second sheet metal strip can preferably be made of a sheet metal, which is initially punched so as to match the formation of the undercut and which is subsequently set on edge appropriately for creating the locking elements, which protrude in the direction of the pressing element, at a right angle to the underside of the accumulator.

In a further advantageous further development, the locking elements on the second sheet metal strip are arranged so as to alternate with the respective adjacent temperature control elements. This means that the locking elements are in each case arranged offset to one another, so that an unintentional release of the bracing device can be prevented therewith.

Advantageously, the first sheet metal strip and/or the second sheet metal strip are set on edge on both sides, in each case on the sides, which face the temperature control elements. The upturn is expedient to the effect that it can contribute to an increased stability of the first sheet metal strip and/or of the second sheet metal strip.

On principle, at least one such a bracing element can in particular be welded, adhered or riveted to the underside of the accumulator. Within the scope of the invention, all conceivable means for arranging at least one bracing element to the underside of the accumulator are protected as well. The bracing device as such can further be embodied within the scope of the invention, so that at least one pretensioning of the pressing element in the direction of the underside of the accumulator occurs.

On principle, the respective temperature control element can be designed in any way, provided that it provides for a temperature control of the accumulator. In the case of preferred embodiments, at least one such temperature control element, preferably all temperature control elements, is a flat pipe, through which a temperature control medium of the temperature control device can flow. This means that, for controlling the temperature of the accumulator during operation of the temperature control device, the temperature control medium flows through the flat pipes, and thus controls the temperature of the accumulator, in particular cools it.

On principle, the pressing element and the at least one temperature control element can be separate parts of the accumulator temperature control arrangement.

Alternatives are also conceivable, in the case of which the pressing element and at least one such temperature control element, which is pretensioned by the pressing element in the direction of the underside, are embodied as a unit, in particular monolithically or from the same material, respectively. This unit, also called a pressing-temperature control unit, thus has such a pressing element and at least one such temperature control element. The unit is thereby preferably made of a metal-containing material, in particular of a metal, for example of aluminum or an aluminum alloy.

Further important features and advantages of the invention follow from the subclaims, from the drawings and from the corresponding figure description by means of the drawings.

It goes without saying that the above-mentioned features and the features, which will be described below, cannot only be used in the respective specified combination, but also in other combinations or alone, without leaving the scope of the invention at hand.

Preferred exemplary embodiments of the invention are illustrated in the drawings and will be described in more detail in the description below, whereby identical reference numerals refer to identical or similar or functionally identical components.

### BRIEF DESCRIPTION OF THE DRAWINGS

In each case schematically,

FIG. 1 shows a spatial view of an accumulator temperature control arrangement in an embodiment alternative comprising bracing elements, which are embodied as stepped shafts,

FIG. 2 shows a top view of a pressing element comprising clamping means arranged thereon, which are embodied as resilient clamping elements,

FIG. 3 shows a spatial view of the accumulator temperature control arrangement from FIG. 1 comprising attached pressing element from FIG. 2,

FIG. 4 shows a sectional illustration in the area of a bracing device from FIG. 3,

FIG. 5 shows an isometric illustration of the bracing device from FIG. 4,

FIG. 6 shows a spatial view of a second embodiment alternative of such an accumulator temperature control arrangement comprising a first sheet metal strip,

FIG. 7 shows an isometric illustration of the first sheet metal strip comprising latching beads arranged thereon as bracing elements,

FIG. 8 shows a sectional illustration of the second embodiment alternative of the accumulator temperature control arrangement from FIG. 6,

FIG. 9 shows a top view of the second embodiment alternative of the accumulator temperature control arrangement from FIG. 6,

FIG. 10 shows a spatial view of a third embodiment alternative of such an accumulator temperature control arrangement comprising a second sheet metal strip,

FIG. 11 shows an isometric illustration of the second sheet metal strip comprising locking elements arranged thereon,

FIG. 12 shows a top view of the pressing element in the third embodiment alternative comprising clamping means arranged thereon, which are embodied as blankings.

### DETAILED DESCRIPTION

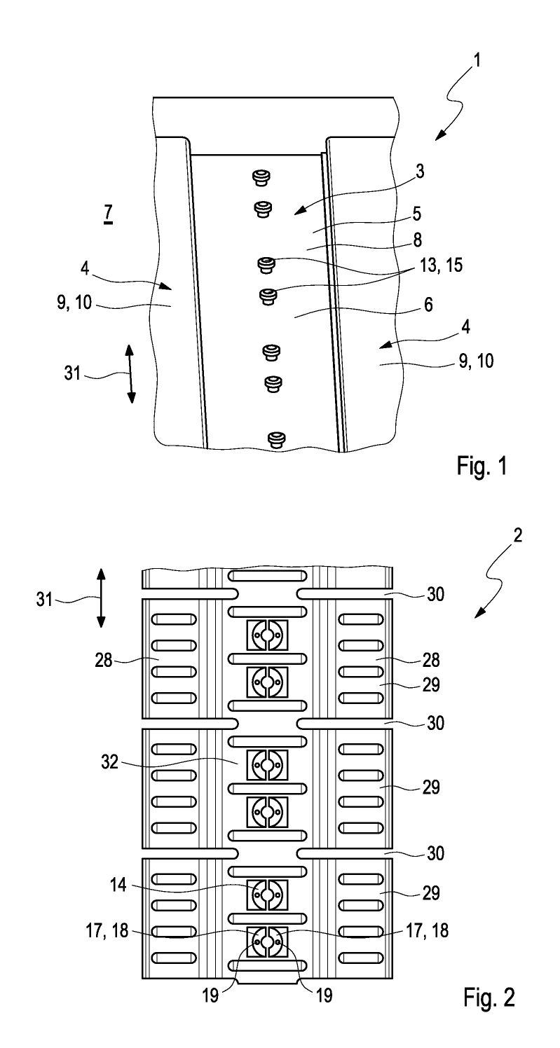

FIG. 1 shows a spatial view of an accumulator temperature control arrangement 1, in particular for a motor vehicle 11, in an embodiment alterative comprising bracing elements 13, which are embodied as stepped shafts 15 (mushroom heads). In the shown illustration, an underside 3 of an electrical accumulator 3 is illustrated, to which the stepped shafts 15 are arranged integrally. The stepped shafts 15 are arranged centrally between two spaced-apart temperature control elements 9 of a temperature control device 4, which are embodied as flat pipes 10. The flat pipes 10 abut directly on the underside 8 of the accumulator 3. The underside 3 in particular describes a housing bottom 6 of an accumulator housing 5, which serves to accommodate accumulator cells 7, which are otherwise not shown. The accumulator cells 7 are in heat-exchanging contact with the housing bottom 6. During operation, a temperature control medium flows through the temperature control elements 9 and thus controls, in particular cools, the temperature of the accumulator 3 or the accumulator cells 7, respectively.

A top view of a pressing element 2 comprising clamping means 14 arranged thereon, which are embodied as resilient clamping elements 17, is shown in FIG. 2. As do the temperature control elements 9, the pressing element 2 extends in a longitudinal direction 31 and has a web 32, which runs in the longitudinal direction 31 and from which a wing 28 in each case protrudes at right angles to the longitudinal direction 31 in opposite directions. The wings 28 extend in the longitudinal direction 31 and can in each case pretension such a temperature control medium 9 in the direction of the underside 8 of the accumulator 3. The pressing element 2 can be embodied symmetrically at right angles to the longitudinal direction 31. It can be seen in the shown example that, in the area of the web 32, the pressing element 2 has such clamping means 14, which are spaced apart from one another in the longitudinal direction 31 and which are arranged centrally with regard to the pressing element 2 and the web 32, in particular at right angles to the longitudinal direction 31. The clamping means 14 are embodied in such a way that they each form a bracing device 12 in pairs with the bracing elements 13 on the underside 8 of the accumulator 3. To realize a homogenous bracing with the help of the bracing devices 12, the bracing devices 12 can be distributed evenly in the longitudinal direction 31 across the length of the pressing element 2 or of the temperature control elements 9, respectively. It can be gathered from FIG. 2 that the wings 28 of the pressing element 2 are in each case embodied so as to be segmented in the longitudinal direction 31. This means that the respective wing 28 has segments 29, which are spaced apart in the longitudinal direction 31, wherein segments 29, which are adjacent in the longitudinal direction 31, are spaced apart from one another in the case at hand by means of a groove 30 of the wing 28, which runs at right angles to the longitudinal direction 31. The segments 29 of the respective wing 28 can thus pretension the corresponding temperature control element 9 independent from one another in the direction of the underside 8 or of the housing bottom 6, respectively, in particular against the underside 8 or the housing bottom 6, respectively. A more homogeneous pretensioning of the temperature control elements 9 in the direction of the underside 8 and/or a better compensation of unevenness and/or tolerances, is thus made.

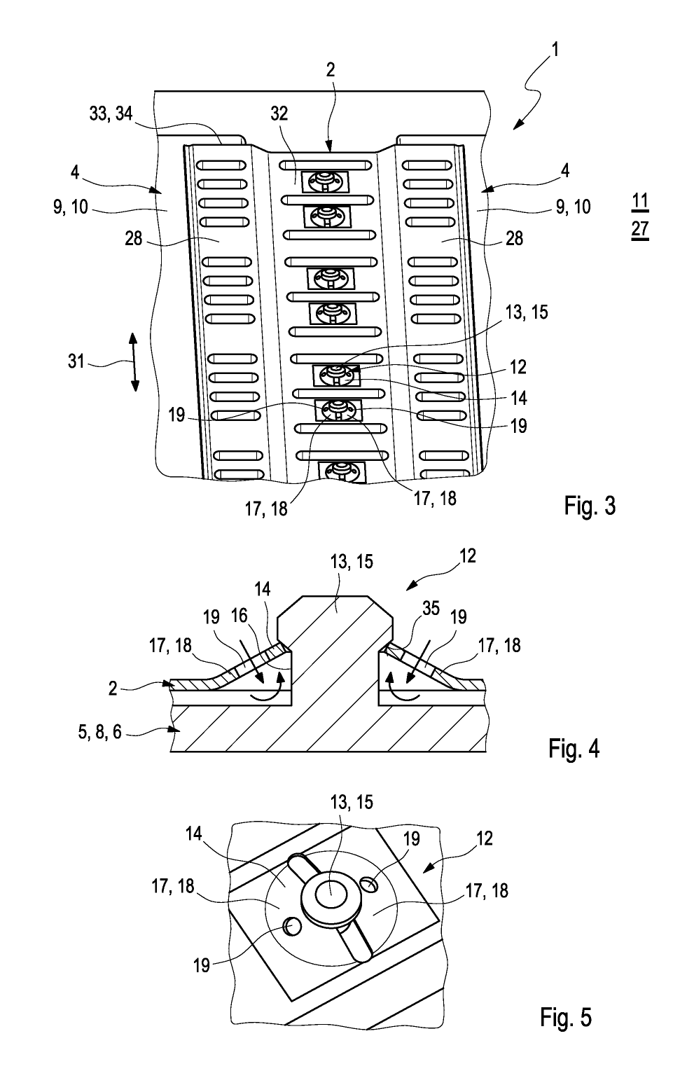

FIG. 3 shows a spatial view of the accumulator temperature control arrangement 1 from FIG. 1 with attached pressing element 2 from FIG. 2. The pressing element 2 is fixedly held on the underside 8 of the accumulator 3 with the help of the bracing device 12, wherein the web 32 is positioned between two adjacent temperature control elements 9. The wings 28 of the pressing element 2, which protrude on both sides at right angles to the longitudinal direction 31, in each case jam such a temperature control element 9 at least partially in the direction of the underside 8 of the accumulator 3. In particular, provision can be made between the respective temperature control element 9 and the underside 8 or the housing bottom 6 of the accumulator 3, respectively, for a layer 33 of heat-conductive material. The respective layer 33 thereby improves the heat transport between the temperature control element 9 and the underside 8 or the underbody 6, respectively, of the accumulator 3 and thus the heat transport between the accumulator cells 7 and the corresponding temperature control element 9. The respective layer 33 is thus in particular a heat conductivity conductive interface 34.

Such a temperature control element 9 is preferably in each case held or pretensioned, respectively, by such a wing 28 of such a pressing element 2 on both sides in the longitudinal direction 31. It is likewise conceivable that a temperature control element 9 is only held or pretensioned, respectively, by such a wing 28. It is further likewise conceivable that the pressing element 2 and at least one such temperature control element 9 is embodied as an integral pressing-temperature control unit 27, which is not shown otherwise.

FIG. 4 shows a sectional illustration of the accumulator temperature control arrangement 1 in the area of the bracing device 12. The bracing element 13, which can be embodied as stepped shaft 15 in the shown example, can preferably be integrally molded on the housing bottom 6 of the accumulator housing 5. The stepped shaft 15 can have a beveled support surface 35, which is created by an undercut 16 and against which the clamping means 14 of the pressing element 2 can be supported in a positive and non-positive manner. The clamping means 14 can have resilient clamping elements 17, which can briefly be elastically deformable in response to locking in place with at least one such bracing element 13.

FIG. 5 shows an isometric illustration of the above-described bracing device 12 from FIG. 4. It can be seen in the illustration that the clamping means 14 is formed from two resilient clamping elements 17, which, in turn, are embodied as semicircles 18, which are spaced apart from one another. The semicircles 18 can be embodied convexly on a side, which faces away from the underside 8 of the accumulator 3. The clamping elements 17 can further each have a tool accommodation 19, which provides for a simplified release of the bracing device 12 with the help of a tool.

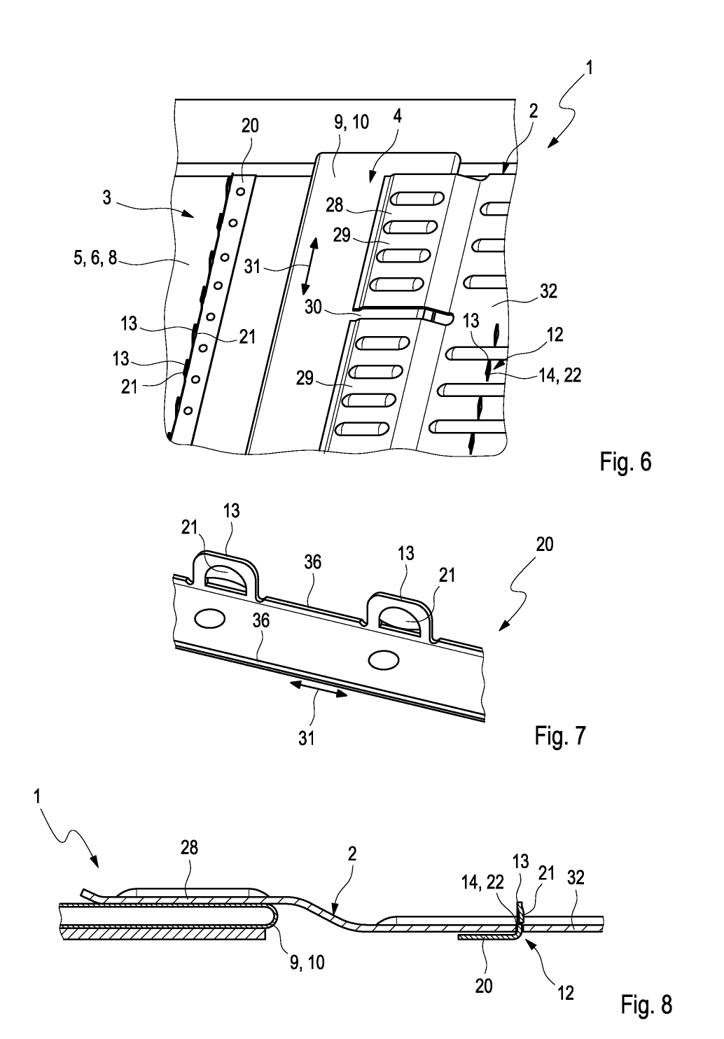

FIG. 6 shows a spatial view of a second embodiment alternative of the accumulator temperature control arrangement 1 comprising a first sheet metal strip 20, which has at least a plurality of bracing elements 13. In contrast to the above-described first embodiment alternative, the bracing elements 13 are not embodied integrally on the housing bottom 6 of the accumulator housing 5, but on a first sheet metal strip 20, which can be attached to the underside 8 of the accumulator 3 subsequently. The first sheet metal strip 20 can be welded, riveted or adhered and is also arranged in the area between two adjacent temperature control elements 9.

FIG. 7 shows an isometric illustration of the first sheet metal strip 20 comprising bracing elements 13 arranged thereon, on which a latching bead 21 is embodied in each case. The first sheet metal strip 20 can in particular be made of a sheet metal, which can be set on edge at least on one side in the area of the bracing elements 13 for creating the bracing elements 13. The bracing elements 13 can protrude orthogonally to the first sheet metal strip 20, in particular on a side, which faces away from the housing bottom 6. The latching beads 21 on the respective bracing elements 13 can be molded convexly at right angles to the longitudinal direction 31. The latching beads 21 can further be arranged on the first sheet metal strip 20 so as to alternate with the respective adjacent temperature control elements 9. By means of the alternating arrangement of the latching beads 21, an unintentional and/or unwanted release of the pressing element 2 can at least be prevented or can at least be made more difficult. Advantageously, the longitudinal sides can be provided with upturns 36 on both sides so as to increase the stability of the first sheet metal strip 20.

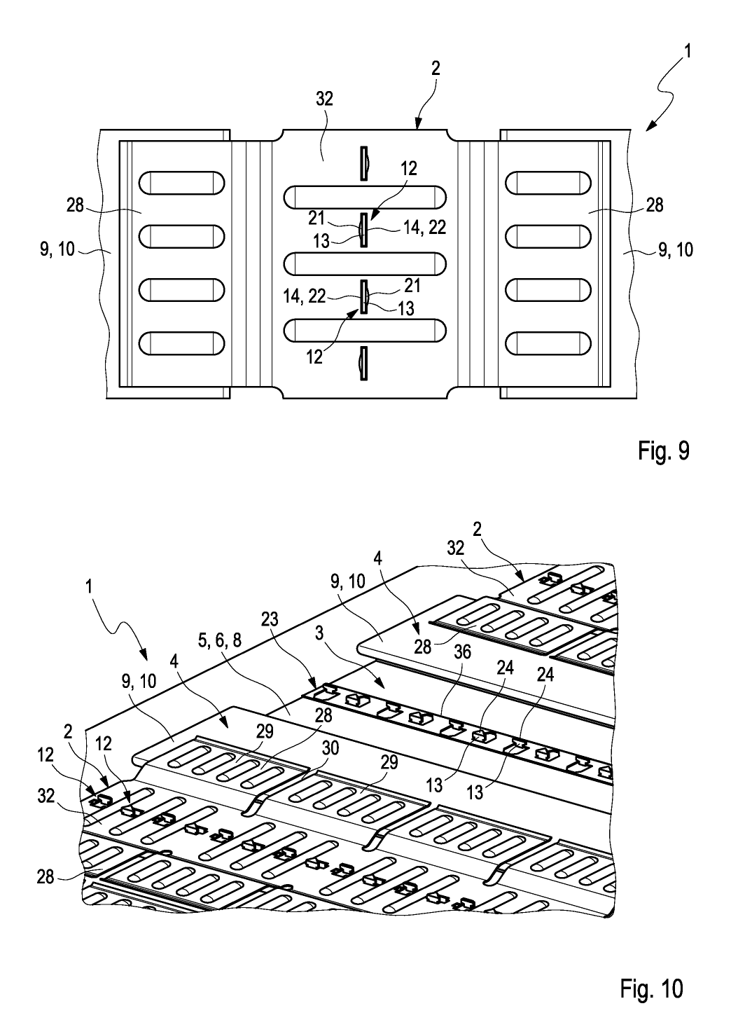

FIG. 8 and FIG. 9 in each case show the second embodiment alternative of such an accumulator temperature control arrangement 1 in a cross section and a top view. The difference to the first embodiment alternative is essentially the different bracing device 12. It can be seen well in FIG. 8 that the bracing element 13 protrudes orthogonally in the direction of the pressing element 2 on the first sheet metal strip 20. The pressing element 2 can preferably be pressed onto the first sheet metal strip 20 in such a way that the bracing elements 13 penetrate through correspondingly embodied blankings 22 on the pressing element 2, which are provided for this purpose. It is hereby essential in particular for the locking connection that the latching bead 21 locks fixedly in place with the pressing element 2, so that the pressing element 2 comprising the wings 28 arranged thereon can at least pretension a temperature control element 9 in the direction of the underside 8 of the accumulator 3.

FIG. 10 shows a spatial view of a third embodiment alternative of the accumulator temperature control arrangement 1 comprising a second sheet metal strip 23. A plurality of locking elements 24, which are directed orthogonally in the direction of the pressing element 2 and which have an undercut 25, protrude on the second sheet metal strip 23. The locking elements 24 together with blankings 26, which are embodied so as to correspond thereto, in each case form the bracing devices 12 on the pressing element 2.

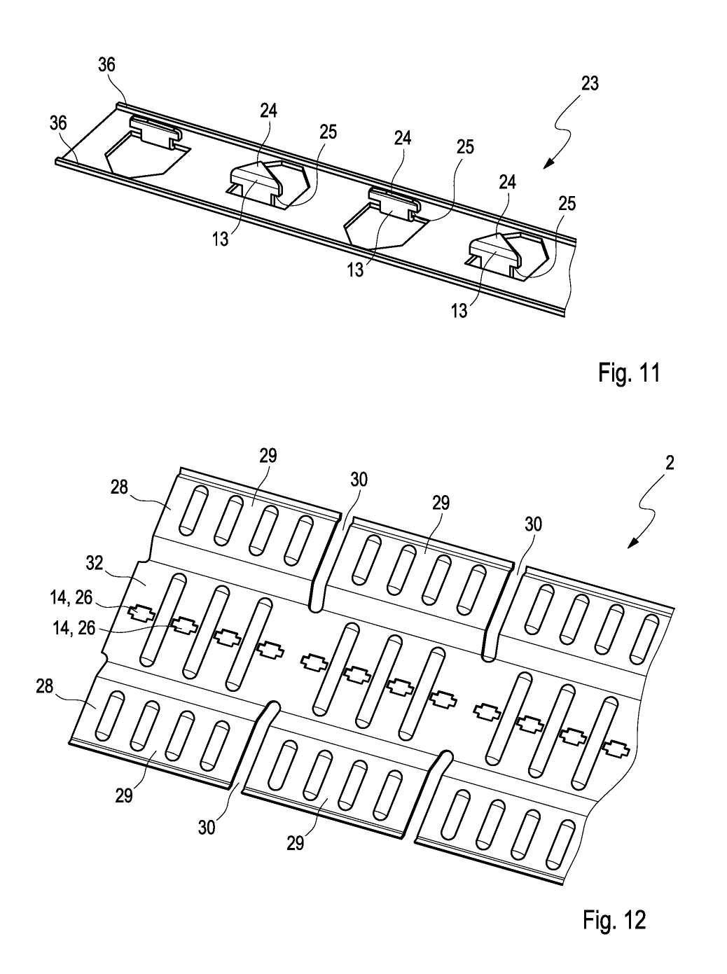

FIG. 11 shows an isometric illustration of the second sheet metal strip 23 comprising the locking elements 24 arranged thereon. The locking elements 24 can be arranged on the second sheet metal strip 23 so as to alternate with their respective adjacent temperature control elements 9. By means of the alternating arrangement of the locking elements 24, an unintentional and/or unwanted release of the pressing element 2 can at least be prevented or can at least be made more difficult. The second sheet metal strip 23 is preferably embodied monolithically. This means that the undercut 25 can for example be embodied by means of a blanking and the protruding locking elements 24 can be embodied by means of an upturn.

FIG. 12 shows a top view of the pressing element 2 comprising clamping means 14 arranged thereon, which are embodied as blankings 26. The blankings 26 are embodied so as to be complementary to the locking elements 24 of the second sheet metal strip 23. This means that the locking elements 24 penetrate the blankings 26 when the pressing element 2 is attached, and lock in place with the pressing element 2 with the help of the undercut 25.

1. An accumulator temperature control arrangement for a motor vehicle, comprising;
an electrical accumulator;
a temperature control device for controlling a temperature of the accumulator, the temperature control device including at least one temperature control element arranged in heat-exchanging contact with an underside of the accumulator;
a pressing element arranged on a side of the at least one temperature control element facing away from the underside, the pressing element pretensioning the at least one temperature control element in a direction of the underside;
at least one bracing element arranged on the underside and facing towards the pressing element; and
wherein the pressing element includes a clamping component corresponding to the at least one bracing element, and wherein the clamping component together with the at least one bracing element provides a bracing device that pretensions the pressing element in the direction of the underside.

2. The accumulator temperature control arrangement according to claim 1, wherein the at least one bracing element is arranged integrally on the underside of the accumulator.

3. The accumulator temperature control arrangement according to claim 1, further comprising a plurality of bracing devices for bracing the pressing element, the plurality of bracing devices including:
a plurality of bracing elements arranged at least one of integrally and monolithically on the underside of the accumulator; and
a plurality of clamping components arranged at least one of integrally and monolithically on the pressing element.

4. The accumulator temperature control arrangement according to claim 1, wherein:
at least one bracing element is a stepped shaft including a defined undercut; and
the clamping component is a resilient clamping element, which is held on the stepped shaft in a non-positive and positive manner and which locks in place with the stepped shaft.

5. The accumulator temperature control arrangement according to claim 4, wherein the clamping element includes two resilient semicircles disposed spaced apart from one another and arranged to face one another.

6. The accumulator temperature control arrangement according to claim 5, wherein at least one of the two resilient semicircles includes a tool accommodation configured to release a locking connection.

7. The accumulator temperature control arrangement according to claim 1, wherein:
the at least one bracing element is a first sheet metal strip including at least one latching bead protruding therefrom in a direction of the clamping component;
the clamping component includes a blanking, which corresponds to one of the first sheet metal strip and the at least one latching bead; and
at least one of the first sheet metal strip and the at least one latching bead is in a non-positive and positive operative connection with the clamping component.

8. The accumulator temperature control arrangement according to claim 7, wherein the at least one latching bead includes a plurality of latching beads arranged such that consecutive latching beads alternate with respect to corresponding to the blanking of adjacent temperature control elements.

9. The accumulator temperature control arrangement according to claim 7, wherein the at least one latching beads is molded convexly to a respective adjacent temperature control element.

10. The accumulator temperature control arrangement according to claim 1 wherein:
the at least one bracing element is a second sheet metal strip including locking elements protruding therefrom and which have an undercut; and
the clamping component includes a blanking which corresponds to the locking elements and which provides for a non-positive and positive accommodation of the locking elements.

11. The accumulator temperature control arrangement according to claim 10, wherein the locking elements are integrally molded on the second sheet metal strip.

12. The accumulator temperature control arrangement according to claim 10, wherein the locking elements are arranged such that consecutive locking elements alternate with respect to corresponding to the blanking of adjacent temperature control elements.

13. The accumulator temperature control arrangement according to claim 11, wherein the first sheet metal strip includes edges which protrude from two sides of the first sheet metal strip, the two sides of the first sheet metal strip facing adjacent temperature control elements, and the edges protrude toward and facilitate contact with the underside of the of the accumulator.

14. The accumulator temperature control arrangement according to claim 1, wherein the at least one bracing element is at least one of welded, adhered, and riveted to the underside of the accumulator.

15. The accumulator temperature control arrangement according to claim 1, wherein the pressing element and the at least one temperature control element are configured as an integral pressing-temperature control unit.

16. A pressing-temperature control unit of an accumulator temperature control arrangement, comprising:
at least one temperature control element configured to contact an underside of an accumulator in a heat-exchanging manner; and
a pressing element integrally arranged on a side of the at least one temperature control element facing away from the underside of the accumulator;
wherein the pressing element includes at least one clamping component that corresponds to a respective bracing element arranged on the underside of the accumulator; and
wherein the at least one clamping component and the respective bracing element provide a bracing device that when engaged with one another, the bracing device pretensions the pressing element in a direction of the underside of the accumulator, which in turn pretensions the at least one temperature control element in the direction of the underside of the accumulator.

17. The accumulator temperature control arrangement according to claim 16, wherein:
the at least one bracing element is a stepped shaft including a defined undercut; and
the clamping component is a resilient clamping element that is held on the stepped shaft in a non-positive and positive manner and which locks in place with the stepped shaft.

18. The accumulator temperature control arrangement according to claim 17, wherein:
the clamping element includes two resilient semicircles disposed spaced apart from one another and arranged to face one another; and
at least one of the two resilient semicircles includes a tool accommodation configured to release a locking connection.

19. The accumulator temperature control arrangement according to claim 16, wherein:
the at least one bracing element is a first sheet metal strip including at least one latching bead protruding therefrom in a direction of the clamping component;
the clamping component includes a blanking that corresponds to one of the first sheet metal strip and the at least one latching bead; and
at least one of the first sheet metal strip and the at least one latching bead is in a non-positive and positive operative connection with the clamping component.

20. The accumulator temperature control arrangement according to claim 19, wherein the at least one latching bead includes a plurality of latching beads arranged such that consecutive latching beads alternate with respect to corresponding to the blanking of adjacent temperature control elements.
